(19) United States
(12) Patent Application Publication
(10) Pub. No.: US 2010/0013922 A1
(43) Pub. Date: Jan. 21, 2010

(54) Surveillance camera

(76) Inventor: Yi-Jen Cheng, Taichung (TW)

Correspondence Address: FRENKEL & ASSOCIATES, 3975 UNIVERSITY DR., STE. 330, FAIRFAX, VA, 22030, US

(21) Appl. No.: 12/378,721

(22) Filed: Feb. 18, 2009

(30) Foreign Application Priority Data
Jul. 15, 2008 (TW) 097212583

(51) Int. Cl. H04N 7/18

(52) U.S. Cl. 348/143; 348/E07.085

(57) ABSTRACT

A surveillance camera has a case, an optoelectronical module and an assistant light module. The optoelectronical module is mounted securely inside the case and has a camera lens and a contact pad module. The contact pad module is a printed circuit board that has at least two contact pads thereon and is mounted adjacent to the camera lens. The assistant light module is detachably mounted around the camera lens and has an assistant light unit. The assistant light unit is detachably mounted around the camera lens and has at least two contact members. Each contact members is disposed corresponding to one of the at least two contact pads and is electronically contacted to a corresponding contact pad when the assistant light unit is mounted in the case.

### BACKGROUND OF THE INVENTION

1. Field of Invention

The present invention relates to a surveillance camera, and more particularly to a surveillance camera with a detachable assistant light source.

2. Description of the Related Art

Surveillance cameras are commonly implemented for crime prevention and property protection for homes, governmental, commercial and industrial buildings as well as outdoors in streets, outside entrances, in high risk areas, or large areas such as ports, airports, bus or train stations and the like. One surveillance camera has to be provided with an assistant light sources therein for providing assistant light when the surveillance camera is installed at a dark place or works at night.

With reference to FIG. 5, a conventional surveillance camera (90) has a case (91), an optoelectronical module (92) and an assistant light source (94). The optoelectronical module (92) is mounted securely inside the case (91) and has a lens (922). The assistant light source (94) is electronically connected to the optoelectronical module (92) adjacent to the lens (922). The assistant light source (94) is controlled by the optoelectronical module (92) to provide an assistant light during the lens (922) captures visions at night.

However, the assistant light source (94) is normally mounted integrally with the optoelectronical module (92) or may be electronically connected securely to the optoelectronical module (92) with wires. Therefore, replacement of the assistant light source (94) is not easy for an end user and the whole set of the surveillance camera (90) has to be sent back to the manufacturer for repairing, and this causes troublesomeness and difficulty in maintaining.

The present invention provides a surveillance camera that has a detachable assistant light source to obviate or mitigate the shortcomings of the conventional surveillance camera.

### SUMMARY OF THE INVENTION

The primary objective of the present invention is to provide a surveillance camera having a detachable assistant light source to improve mountainous flexibility for end users to easily replace the assistant light source in the surveillance camera.

The surveillance camera has a case, an optoelectronical module and an assistant light module. The optoelectronical module is mounted securely inside the case and has a camera lens and a contact pad module. The contact pad module is a printed circuit board that has at least two contact pads thereon and is mounted adjacent to the camera lens. The assistant light module is detachably mounted around the camera lens and has an assistant light unit. The assistant light unit is detachably mounted around the camera lens and has at least two contact members. Each contact members is disposed corresponding to one of the at least two contact pads and is electronically contacted to a corresponding contact pad when the assistant light unit is mounted in the case.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a surveillance camera in accordance with the present invention;

FIG. 2 is a partially exploded perspective view of the surveillance camera in FIG. 1;

FIGS. 3 is a front view in partial section of the surveillance camera having three rectangular contact pads in FIG. 1;

FIG. 4 is a front view in partial section of the surveillance camera having two arc shaped contact pads in FIG. 1; and

FIG. 6 is a perspective view in partial section of a conventional surveillance camera in accordance with the prior art.

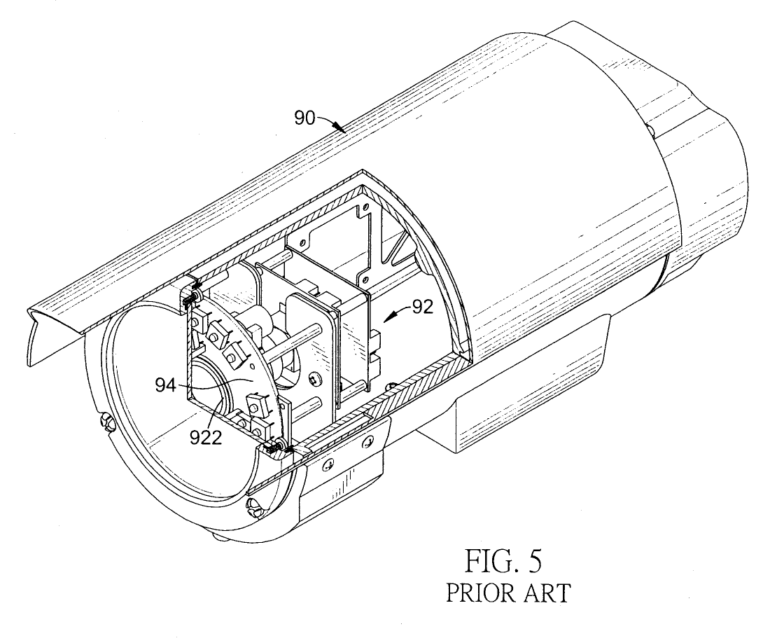

### DETAILED DESCRIPTION OF THE INVENTION

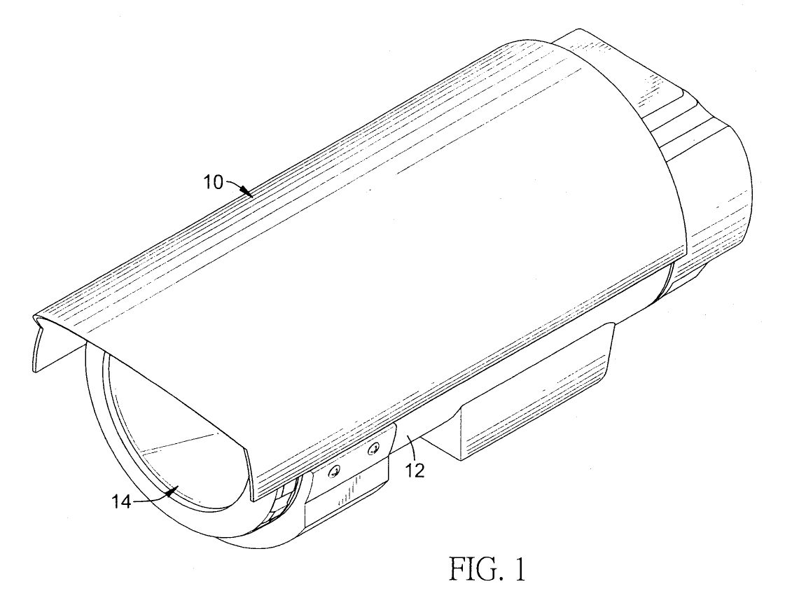

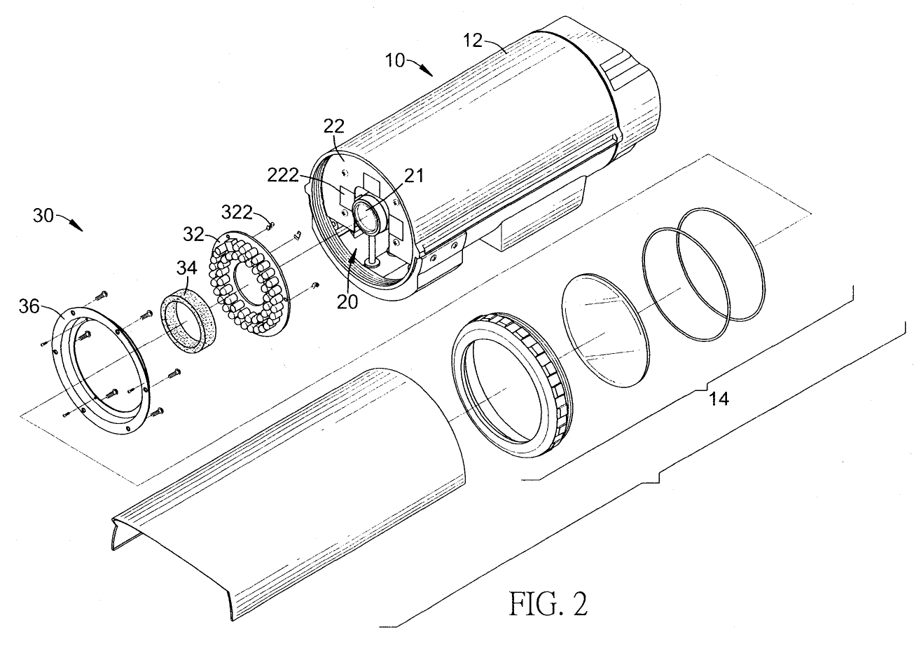

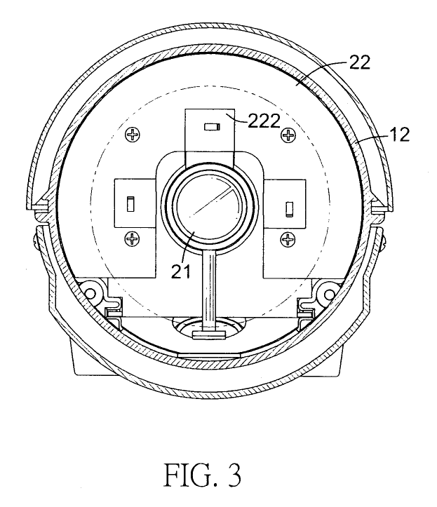

With reference to FIGS. 1, 2 and 3, a surveillance camera in accordance with the present invention comprises a case (10), an optoelectronical module (20) and an assistant light module (30).

The case (10) may be shaped as a hemispheroid, a round tube or a polygonous tube and has a body (12) and a front cover (14). The body (12) has an opening. The front cover (14) is mounted on the opening of the body (12).

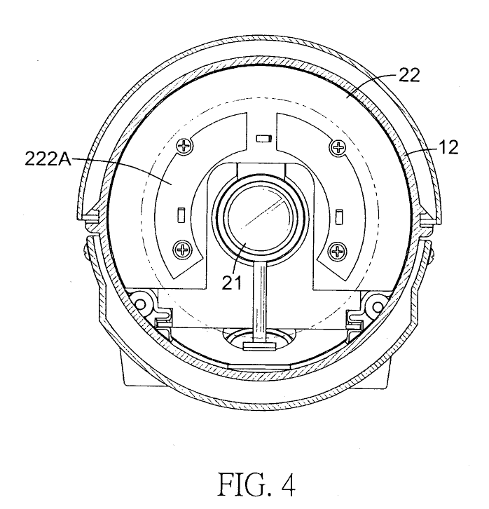

With reference to FIG. 4, the optoelectronical module (20) is capable of successively capturing light to generate a video image, is mounted securely inside the case (10) and has a camera lens (21) and a contact pad module (22). The camera lens (21) is disposed toward the opening of the case (10). The contact pad module (22) is a printed circuit board that has at least two contact pads (222, 222A) thereon and may be mounted adjacent to the camera lens (21). Each contact pad (222, 222A) is electronically conductible, is disposed toward the opening of the body (12) and may be a rectangular (222) or an arc shaped conductible pad (222A).

The assistant light module (30) is detachably mounted in the case (10) around the camera lens (21) and has an assistant light unit (32), a shuttering ring (34) and a fixing member (36).

The assistant light unit (32) is a circuit board having multiple luminescent elements thereon, is detachably mounted around the camera lens (21) and has a bottom surface, a top surface, at least two contact members (322) and may have a sensing element. The luminescent elements may be light emitting diodes. The contact members (322) are mounted on the bottom surface of the assistant light unit (32). Each contact members (322) are disposed corresponding to one of the at least two contact pads (222), electronically contacts to a corresponding contact pad (222) and transmits electric power provided from the optoelectronical module (20) to the luminescent elements when the assistant light unit (32) is mounted in the case (10). In a first embodiment of the present invention, the assistant light unit (32) has three contact members (322) and the contact pad module (22) has three contact pads (222). Two of the three contact members (322) are respectively connected to positive and negative electrodes of the luminescent elements. The other contact member (322) is connected to the sensing element. The sensing element may be a motion sensor or a brightness sensor that are respectively used for sensing human passing or environment brightness changing for the optoelectronical module (20) to turn on the assistant light module (30).

The shuttering ring (34) is non-transparent and is mounted around the camera lens (21) to prevent a low contrast ratio of the video image that is caused by the light from the assistant light unit (32).

The fixing member (36) is shaped corresponding to the opening of the body (12) and is securely mounted in the case (10) to limit movements of the assistant light unit (32) and the shuttering ring (34).

Hence, since the assistant light unit (32) detachably and electronically contacts to the contact pad module (22) but is not securely mounted on the optoelectronical module (20), a person may easily replace or uninstall the assistant light unit (32) from the case (10) just by removing the fixing member (36) and the shuttering ring (34).

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A surveillance camera comprising
a case having
a body having an opening; and
a front cover being mounted on the opening of the body;
an optoelectronical module being capable of successively capturing light to generate a video image, being mounted securely inside the case and having
a camera lens being disposed toward the opening of the body; and
a contact pad module being a printed circuit board that has at least two contact pads thereon and being mounted adjacent to the camera lens, each contact pad being disposed toward the opening of the body; and
an assistant light module being detachably mounted in the case around the camera lens and having
an assistant light unit being a circuit board having multiple luminescent elements thereon, being detachably mounted around the camera lens and having
a bottom surface;
a top surface; and
at least two contact members being mounted on the bottom surface of the assistant light unit, each contact member being disposed corresponding to one of the at least two contact pads and being electronically contacted to a corresponding contact pad when the assistant light unit is mounted in the case; and
a fixing member being shaped corresponding to the opening of the body and being securely mounted in the case to limit movements of the assistant light unit.

2. The surveillance camera as claimed in claim 1, wherein the assistant light module further has a shuttering ring and the shuttering ring is non-transparent and is mounted around the camera lens.

3. The surveillance camera as claimed in claim 1, wherein
the contact pads are rectangular; and
the assistant light unit are light emitting diodes.

4. The surveillance camera as claimed in claim 2, wherein
the contact pads are rectangular; and
the assistant light unit are light emitting diodes.

5. The surveillance camera as claimed in claim 1, wherein
the contact pads are arc shaped; and
the assistant light unit are light emitting diodes.

6. The surveillance camera as claimed in claim 2, wherein
the contact pads are arc shaped; and
the assistant light unit are light emitting diodes.

7. The surveillance camera as claimed in claim 4, wherein the assistant light unit has three contact members and the contact pad module has three contact pads.
